(19) United States
(12) Patent Application Publication
(10) Pub. No.: US 2020/0345586 A1
(43) Pub. Date: Nov. 5, 2020

(54) OVERNIGHT HYDRATION SYSTEM

(71) Applicant: James C. Craig, Philadelphia, PA (US)

(72) Inventor: James C. Craig, Philadelphia, PA (US)

(21) Appl. No.: 16/402,640

(22) Filed: May 3, 2019

(51) Int. Cl. A61J 7/00

(52) U.S. Cl. CPC A61J 7/0053

(57) ABSTRACT

A hydration system for use at night a providing hydration to a mouth of a person. The person may wish to be hydrated after a night of drinking to help hydrate and reduce hangovers, athletes to be hydrated prior to early morning competitions, fitness enthusiasts being hydrated prior to early morning workouts, patients being medicated, etc. The hydration system has a container that has a basin for containing a liquid. The container has a control board coupled to the container to control an outputting of the liquid from the container. The container further has a power source for providing electrical current to the control board. The hydration system has a connecting tube a conduit for the liquid. The hydration system has a mouthguard that has a receiving port, a first opening and a second opening. The mouthguard receives the liquid from the connecting tube at the receiving port and releases the liquid through the first opening and second opening to the mouth of the person.

### FIELD OF THE INVENTION

This invention relates to mouth guards. More particularly, it relates to hydration for mouth guards.

### BACKGROUND

A mouthguard is a protective device for the mouth that covers the teeth and gums to prevent and reduce injury to the teeth, arches, lips and gums. A mouthguard is most often used to prevent injury in contact sports, as a treatment for bruxism or TMD, or as part of certain dental procedures, such as tooth bleaching or sleep apnea. Depending on application, it may also be called a mouth protector, mouth piece, gumshield, gum-guard, nightguard, occlusal splint, bite splint, or bite plane. Mouthguards may also be used by those for non-medical or dental purposes.

There are different types of mouthguards such as:
Stock or readymade—Manufactured in a pre-formed shape in various sizes but with nearly no adjustment to fit the user's mouth. The only adjustment possible is minor trimming with a knife or scissors.
Mouth adapted or “boil and bite”—A thermoplastic material manufactured in a pre-formed shape in various sizes that can be adapted to fit more closely to an individual's teeth and gums by heating and molding such as boiling then placing in the mouth. Some are now available that incorporate special fins within the fitting zones which increase retention and give an improved fit over traditional boil and bite mouth types. Guards are usually made of Ethylene-vinyl acetate, commonly known as EVA. Some of the newer technologies offer an alternative, stronger thermo-polymer that allows for lower molding temperatures, below 140 F to prevent burning by scalding hot water. This is the most popular mouthguard used by amateur and semi-professional sportsmen, providing adequate protection but relatively low comfort in comparison to the custom-made guard.
Custom-made—An impression of the user's teeth is used by specialist manufacturers to create a best-fit mouth protector. The impression may be obtained by using a specially designed impression kit that uses dental putty, or from a dentist who will take an impression in dental alginate material. One company uses 3D imaging to create a digital impression. The resulting impression is sent to a lab that makes a guard from the impression.

Often people desire to be hydrated. The mouthguard is a good method for protecting the teeth by has not been used to provide for the other needs of the users. Therefore, there is a need for a hydration or liquid providing system that is able to provide liquid to a mouthguard whether at night during sleep or while lounging.

### BRIEF DESCRIPTION OF THE DRAWINGS

FIG. 1 is an illustrated view of an exemplary hydration system.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

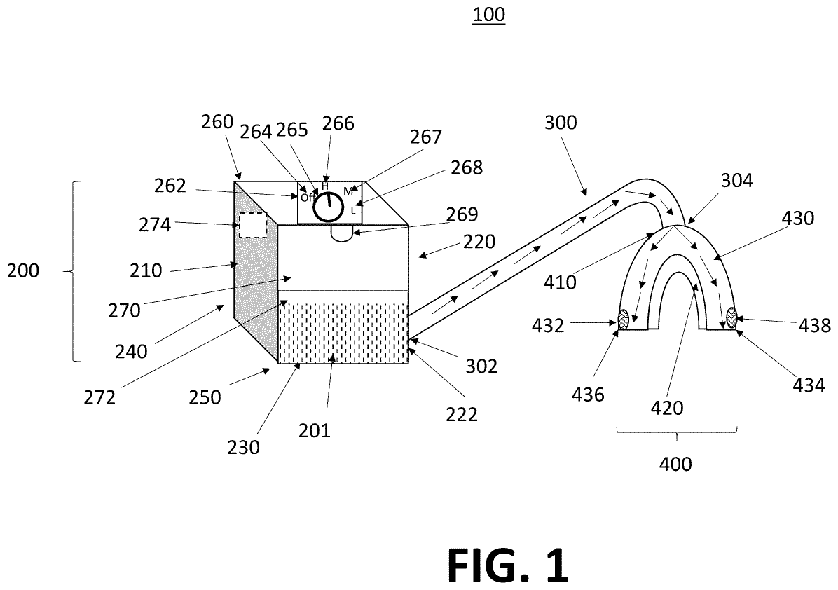

Referring to FIG. 1, illustration of an exemplary hydration system 100 for overnight mouth hydration is shown. The hydration system 100 is useful for overnight hydration when a person has consumed alcohol to help prevent dehydration and hangover, for athletes or fitness enthusiast wishing to hydrate before an early morning athletic competition and/or workout, elderly or other people in need of assistance in stay adequately hydrated and/or nourished.

The hydration system 100 has a container 200, a connecting tube 300 and a mouthguard 400. The connecting tube 300 is useful in the providing a conduit for the movement of a liquid 201 of the container 200 to the mouthguard 400. The connecting tube 300 is preferably made of a plastic material, but may be made of other materials such as copper, PVC, high-density polyethylene (HDPE), etc.

The container 200 of the hydration system 100 has a first side 210, a second side 220, a, front 230, a back 240, a bottom 250, a top 260 and an interior 270.

The interior 270 has a basin 272. The basin 272 is useful in preferably holding up to sixty-four (64) ounces of the liquid 201 but the basin 272 may hold larger amounts as desired. The liquid 201 is preferably water, but may be other types of liquid such as medications, electrolytic water, protein, liquid based nutritional substances, etc. The basin 272 is preferably made of a hard plastic, but may be made of other materials such as copper, PVC, high-density polyethylene (HDPE), etc. The basin 272 is preferably bowl shaped but may be any shape desired and fits properly inside of the container 200 of the hydration system 100.

The interior 270 of the container 200 of the hydration system 100 further has a power source 274. The power source 274 is useful for providing electrical current to the container 200 to provide the liquid 272 to the connecting tube 300. The power source 274 is preferably a rechargeable battery, but may be other power sources such as solar, ac/dc, disposable battery, etc. The basin 272 of the interior 270 of the container 200 further has a mechanism (not shown) for pushing the liquid 201 through the hydration system 100. The mechanism pushes the liquid 201 with such force that it is pushed through the mouthguard 400.

The top 260 of the container 200 of the hydration system 100 has a control board 262. Although, the control board 262 is shown and described on the top 260 of the container 200 of the hydration system 100 the control board 262 may be on other areas of the container 200 or remote. The control board is preferably a toggle switch but may be touchscreen, remotely accessed by an app on a smart phone, etc.

The control board 262 of the top 260 of the container 200 of the hydration system 100 has a switch 264. The switch 264 is useful for setting the output to a preset or predetermined output value. The switch 264 of the control board 260 has an Off position 265, a high setting (“H) 266, a medium setting (“M”) 267, and a low setting (“L”) 268. Though, it is shown the settings 265, 266, 267, 268 there may be more or fewer setting and the settings may be labeled and produce different predetermined output of the liquid 201 of the container 200.

The Off position 265 is useful for turning the hydration system 100 off when not in use. The high setting 266 is preferably predetermined to output (one quarter) 0.25 ounces of liquid 201 every two (2) minutes (which equates to seven and one-half ounces every hour (7.5 oz/hr.) or sixty (60) ounces in an eight-hour period), though the predetermined value may output more or less depending on the desired outputted amount.

The medium setting 267 is preferably predetermined to output (one quarter) 0.25 ounces of liquid 201 every four (4) minutes (which equates to three and three quarters ounces every hour (3.75 oz/hr.) or thirty (30) ounces in an eight-hour period), though the predetermined value may output more or less depending on the desired outputted amount.

The low setting 268 is preferably predetermined to output (one quarter) 0.25 ounces of liquid 201 every eight (8) minutes (which equates to one and one hundred eighty-five thousand ounces every hour (1.185 oz/hr.) or fifteen (15) ounces in an eight-hour period), though the predetermined value may output more or less depending on the desired outputted amount.

The top 260 of the container 200 may be removable and act as a lid or opening to input the liquid 201 into the basin 272 of the interior 270 of the container. The top 260 has a latch 269. The latch 269 is securely coupled to the top 260 of the container 200. The latch 269 is removably coupled to the front 230 of the container 200.

The second side 220 has an output port 222. The output port 222 of the second side 220 of the container 200 is coupled to a proximal end 302 of the connecting tube 300. The output port 222 of the second side 220 of the container 200 may be positioned on any area of the container 200 as desired. The output port 222 of the container 200 is useful in providing a coupling to the connecting tube 300 to output the liquid 201 of the container 200 towards the mouthguard 400.

The mouthguard 400 of the hydration system 100 is useful for being placed inside of a mouth of a user and the liquid 210 outputted by the mechanism of the basin 272 of the interior 270 of the container 200 of the hydration system 100 and carried through the connecting tube 300 of the hydration system 100 where a mechanism delivers the liquid to be released into the mouth of the user such that the user reaps the benefits of the liquid 201.

The mouthguard 400 of the hydration system 100 has an input port 410, an inner lining 420 and an outer lining 430. The input port 410 is useful for receiving the liquid 201 dispensed from the basin 272 of the container 200 through the connecting tube 300. The input port 410 is communicatively coupled to a distal end 304 of the connecting tube 300. The mouthguard 400 is preferably made of a plastic material but may be made of any material. The mouthguard 400 is preferably a custom made such that there is an exact fit for the user, but may be stock, mouth-adapted, etc.

The outer portion 430 has a first side 432 and a second side 434. The first side 432 of the outer portion 430 of the mouthguard 400 has a first opening 436. The first opening 436 of the first side 432 provides an opening such that the liquid 201 of the container 200 is dispensed or released into the mouth or inner cheek area of the user.

The outer portion 430 of the mouthguard 400 is coupled to the input port 410 of the mouthguard 400. The liquid 201 of the container 200 that is received at the input port 410 of the mouthguard 400 via the connecting tube 300 is collected in the outer portion 430 of the mouthguard 400.

The second side 434 of the outer portion 430 of the mouthguard 400 has a second opening 438. The second opening 438 of the second side 434 provides an opening such that the liquid 201 of the container 200 is dispensed or released into the mouth or inner cheek area of the user. The second opening 438 and the first opening 436 are preferably the same size, but the first opening 436 may be larger than the second opening 438 or the second opening 438 may be larger than the first opening 436.

The liquid 201 is received through the input port 410 of the mouthguard 400 into the outer portion 430 of the mouthguard 400. The mechanism of the basin 272 of the interior 270 of the container 200 pushes the liquid 201 with enough force that the liquid 201 from the outer portion 430 of the mouthguard 400 to the first opening 436 of the first side 432 and the second opening 438 of the second side 434 such that the liquid 201 is dispensed or released into the mouth or inner cheek area of the user.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A hydration system for providing hydration to a mouth of a person, the system comprising:
a container, the container having a basin, wherein the basin having a liquid;
a control board, the control board coupled to the container and for controlling an outputting of the liquid from the container;
a power source, the power source for providing electrical current to the control board;
a connecting tube, the connecting tube being a conduit for the liquid; and
a mouthguard, the mouthguard having a receiving port, a first opening and a second opening; wherein the mouthguard receives the liquid from the connecting tube at the receiving port and releasing the liquid through the first opening and second opening to the mouth of the person.

2. The system of claim 1, further comprising:
an interior of the container, the interior having a basin for storing liquid.

3. The system of claim 1, wherein the control board being a toggle control board.

4. The system of claim 1, wherein the outputting of the liquid is predefined output being high, medium and low.

5. The system of claim 4, wherein the medium predefined output being one-quarter (0.25) ounces every four (4) minutes.

6. The system of claim 4, wherein the high predefined output being one-quarter (0.25) ounces every two (2) minutes.

7. The system of claim 4, wherein the low predefined output being one-quarter (0.25) ounces every eight (8) minutes.

8. The system of claim 1, wherein the basin having a capacity of sixty-four ounces.

9. The system of claim 1, wherein the liquid being water.

10. The system of claim 1, wherein the liquid being medicine.

11. The system of claim 1, wherein the control board being controlled by an app on a smart phone.

12. The system of claim 1, wherein the control board being touchscreen.

13. The system of claim 1, wherein the mouthguard being custom-made.

14. The system of claim 1, wherein the mouthguard being mouth-adapted.

15. The system of claim 1, wherein the mouthguard being made of a plastic material.

16. The system of claim 1, wherein the connecting tube being made of a plastic material.

17. The system of claim 1, wherein the basin being made of a plastic material.
